(19) United States
(12) Patent Application Publication
(10) Pub. No.: US 2026/0091679 A1
(43) Pub. Date: Apr. 2, 2026

(54) VEHICLE CONTROL APPARATUS AND CONTROL METHOD THEREOF

(71) Applicant: HYUNDAI MOBIS CO., LTD., Seoul (KR)

(72) Inventor: Seung Jae Kim, Yongin-si (KR)

(73) Assignee: HYUNDAI MOBIS CO., LTD., Seoul (KR)

(21) Appl. No.: 19/277,247

(22) Filed: Jul. 22, 2025

(30) Foreign Application Priority Data
Oct. 2, 2024 (KR) 10-2024-0133672

(51) Int. Cl. B60K 35/81; B60K 35/28; B60K 35/55

(52) U.S. Cl. CPC B60K 35/81; B60K 35/28; B60K 35/55; B60K 2360/1468; B60K 2360/182

(57) ABSTRACT

Provided are a vehicle control apparatus and a control method thereof. The vehicle control apparatus includes a display device provided in a vehicle body, in which the display device includes a display including a first area, a second area and a third area to display visual information, a drive assembly configured to change at least one of a shape of the display and a position of the display, and a controller configured to control the display and the drive assembly, and in which the controller is further configured to control brief information displayed in the second area to be specified and displayed as detailed information in the first area or control detailed information displayed in the first area to be simplified and displayed as brief information in the second area.

This application claims the benefit of Korean Patent Application No. 10-2024-0133672, filed on Oct. 2, 2024, which is hereby incorporated by reference as if fully set forth herein.

### BACKGROUND

### Technical Field

The present disclosure relates to a vehicle control apparatus and a control method thereof, and more particularly, to a vehicle control apparatus and a control method thereof to flexibly use a display in a vehicle.

### Discussion of the Related Art

Generally, various display apparatuses capable of displaying images and visual information are installed and used in vehicles. One of them may be installed around a driver's seat, for example, on a dashboard, in a vehicle.

If a size of a display screen provided by the display device installed on the dashboard is large, a variety of and a lot of information may be transmitted to a driver and/or an occupant through a single display screen, but the possibility of interference between the display screen and other devices installed in the vehicle may increase, obstructing a view of the driver and/or the occupant.

On the other hand, if the size of the display screen is small, information that may be provided through the single display screen may be reduced, whereas the possibility of interference between the display screen and the other devices installed in the vehicle may be low, reducing the possibility of obstructing the view of the driver and/or the occupant.

### SUMMARY

The present disclosure is proposed to solve the above-described problems and various problems related thereto, and aims to provide a vehicle control apparatus and a control method thereof to flexibly adjust a display installed in a vehicle.

The present disclosure also aims to provide a vehicle control apparatus and a control method thereof to organizationally provide information by using a plurality of display areas in a flexible display structure.

However, the present disclosure is not limited to the technical problems described above, and the scope of the embodiments may be expanded to other technical problems that may be construed by those of ordinary skill in the art based on the entire contents of the present document.

To achieve the foregoing objects and other advantages, a vehicle control apparatus includes a vehicle body and a display device provided in the vehicle body, in which the display device includes a display configured to display visual information, a driving unit configured to change at least one of a shape of the display and a position of the display, and a controller configured to control the display and the driving unit.

According to embodiments, a display area of the display is divided into a first area, a second area, and a third area arranged on a same surface, the second area is positioned above the first area, and the third area is positioned under the first area, and at least one of the second area and the third area is folded or unfolded at a specific angle by the driving unit.

According to embodiments, the controller may be further configured to control brief information displayed in the second area to be specified and displayed as detailed information in the first area or control detailed information displayed in the first area to be simplified and displayed as brief information in the second area.

According to embodiments, the controller may be further configured to control a message including a text indicating an event to be displayed as brief information in the second area, upon identifying occurrence of the event.

According to embodiments, the controller may be further configured to identify that the event occurs when at least one warning light is displayed on a cluster of the vehicle body.

According to embodiments, the controller may be further configured to control the driving unit to unfold the second area and the message to be displayed in the second area when the second area is in a folded state upon occurrence of the event.

According to embodiments, the brief information displayed in the second area may include at least one on/off-settable item.

According to embodiments, the controller may be further configured to control the brief information displayed in the second area to be specified and displayed as detailed information in the first area when a user touches a screen or makes a gesture to push down the screen using a finger.

According to embodiments, the controller may be further configured to control the detailed information displayed in the first area to be simplified and displayed as brief information in the second area when the user touches the screen or makes a gesture to push up the screen.

According to embodiments, the controller may be further configured to control the first area and the second area to be combined into one screen and the detailed information displayed in the first area to be displayed on the combined screen when the user touches the screen or makes the gesture to push up the screen.

According to embodiments, the vehicle body may further include a hidden area hidden by a partial area of the display, and the driving unit may be further configured to expose or avoid exposing the hidden area by changing the position of the display.

According to embodiments, the driving unit may be further configured to change the shape of the display by folding or unfolding a part of the display at a specific angle and to change the position of the display by moving the display upwardly or downwardly through sliding.

According to embodiments, a vehicle control method includes changing at least one of a shape of a display of a display device provided in a vehicle and a position of the display and displaying information on the display.

According to embodiments, a display area of the display is divided into a first area, a second area, and a third area arranged on a same surface, the second area is positioned above the first area, and the third area is positioned under the first area, and at least one of the second area and the third area is folded or unfolded at a specific angle by the driving unit.

According to embodiments, the displaying of the information may include specifying brief information displayed in the second area and displaying the specified information as detailed information in the first area or simplifying the detailed information displayed in the first area and displaying the simplified information as brief information in the second area.

According to embodiments, the displaying of the information may include displaying a message including a text indicating an event as brief information in the second area, upon identifying occurrence of the event.

According to embodiments, the displaying of the information may include identifying that the event occurs when at least one warning light is displayed on a cluster of the vehicle body.

According to embodiments, the second area may be unfolded and the message may be displayed in the second area when the second area is in a folded state upon occurrence of the event.

According to embodiments, the brief information displayed in the second area may include at least one on/off-settable item.

According to embodiments, the displaying of the information may include specifying the brief information displayed in the second area and displaying the specified information as detailed information in the first area when the user touches the screen or makes the gesture to push down the screen using a finger.

According to embodiments, the displaying of the information may include simplifying the detailed information displayed in the first area and displaying the simplified information as brief information in the first area when the user touches the screen or makes the gesture to push up the screen using a finger.

According to embodiments, the displaying of the information may include combining the first area and the second area into one screen and displaying the detailed information displayed in the first area on the combined screen when the user touches the screen or makes the gesture to push up the screen.

According to embodiments, the vehicle body may further include a hidden area hidden by a partial area of the display, and the vehicle control method may further include exposing or avoiding exposing the hidden area by changing the position of the display.

According to embodiments, the shape of the display may be changed by folding or unfolding a part of the display at a specific angle, and the position of the display may be changed by moving the display upwardly or downwardly through sliding.

According to embodiments, a computer program stored on a computer-readable recording medium may be combined with a computer, which is hardware, to perform the method.

The above-described solutions are merely some of various embodiments of the present specification, and those of ordinary skill in the art to which the present specification pertains may infer modified embodiments reflecting the technical features of the present specification through the overall intent described in the present specification.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an example of a vehicle according to embodiments;

FIG. 2 shows an example of an inner side of a vehicle according to embodiments;

FIG. 3 is a block diagram of an example of a display device according to embodiments;

FIG. 4 shows an example of a display of a display device according to embodiments;

FIG. 5(a) to FIG. 5(c) show examples of shape change and position change of a display in first to third modes, according to embodiments;

FIG. 6(a) to FIG. 6(d) show an example showing an event displayed in a second area in case of occurrence of the event, according to embodiments;

FIG. 7(a) and FIG. 7(b) show an example of information conversion according to embodiments;

FIG. 8 is a flowchart of an example of an information conversion method according to embodiments;

FIG. 9(a) and FIG. 9(b) show another example of information conversion according to embodiments;

FIG. 10(a) shows examples of setting items of a first area according to embodiments, and FIG. 10(b) shows examples of on/off setting items of a second area;

FIG. 11 is a flowchart of another example of an information conversion method according to embodiments;

FIG. 12(a) and FIG. 12(b) show another example of information conversion according to embodiments; and

FIG. 13 is a flowchart of another example of an information conversion method according to embodiments.

### DETAILED DESCRIPTION

Hereinafter, embodiments disclosed herein will be described in detail with reference to the accompanying drawings, and the same or similar components are given the same reference numerals, and redundant description thereof will be omitted. The following embodiment is to specify the present disclosure, but is not intended to limit the scope of rights of the present disclosure. It is interpreted that what those of ordinary skill in the art can easily infer from the detailed description and embodiments of the present disclosure falls within the scope of the rights of the present document.

The detailed description of the present document should not be construed in any way as restrictive and should be considered illustrative only. The scope of the present document should be determined by a reasonable interpretation of the appended claims, and all changes within the equivalent scope of the present document are included within the scope of the present document.

Meanwhile, blocks in the attached block diagrams or operations in the attached flowcharts may be implemented directly in hardware, implemented as software modules executed by hardware, or implemented by a combination thereof. In addition, the blocks in the attached block diagrams or the operations in the attached flowcharts may be interpreted as computer program instructions that are loaded into a processor or memory of data processible equipment, such as a general-purpose computer, a special-purpose computer, a portable laptop computer, a network computer, etc., and perform designated functions. As these computer program instructions may be stored in a memory provided in a computer device or a computer-readable memory, the functions described in the blocks of the block diagrams or the operations of the flowcharts may also be produced by an article that includes instruction means for executing the same. In addition, each block or operation may indicate a part of a module, segment or code including one or more executable instructions for executing specific logical function(s). In some alternative embodiments, the functions mentioned in the blocks or operations may be executed out of the specified order. For example, two blocks or operations shown in succession may be performed substantially simultaneously, may be performed in reverse order, or may be performed with some blocks or operations omitted.

The present disclosure relates to an apparatus for vehicle control and a control method of the apparatus, and aims to provide a display device including a foldable function and/or a sliding function. To this end, the display device according to the present disclosure may include a flexible display. In the present disclosure, the display device may be used interchangeably with a flexible display device for the same meaning, and the display may be used interchangeably with a flexible display for the same meaning.

In the present disclosure, the display may perform only the foldable function or both the foldable function and the sliding function at the same time, depending on a mode. In the present disclosure, the mode may be referred to as a driving mode or a display mode.

In the present disclosure, the foldable function may mean a function of a part of the display being folded or unfolded at a specific angle, and the sliding function may mean a function of a position of the display being changed as the display physically moves in a specific direction (e.g., up/down). In the present disclosure, a state of a part of the display being bent at a specific angle may be referred to as a folded state (or a folding state), and a state of the part of the display being unfolded may be referred to as an unfolded state (or an unfolding state). In the present disclosure, the shape (or form) of the display may be changed by the foldable function, and the position of the display may be changed by the sliding function.

In the present disclosure, the flexible display may include a plurality of display areas. In an embodiment of the present disclosure, the flexible display may be divided into a first area, a second area, and a third area. In an embodiment of the present disclosure, the first area may be positioned between the second area and the third area, and may be a main area that maintains a planar state at all times. The second area and the third area may be referred to as sub areas in which the display is foldable, i.e., is foldable or unfoldable at a specific angle.

In the present disclosure, according to a user's selection or whether an event occurs, detailed information of the first area may be simplified so as to be displayed as brief information in the second area or the brief information of the second area may be specified so as to be displayed as detailed information in the first area.

In the present disclosure, the user may mean a driver or an occupant other than the driver.

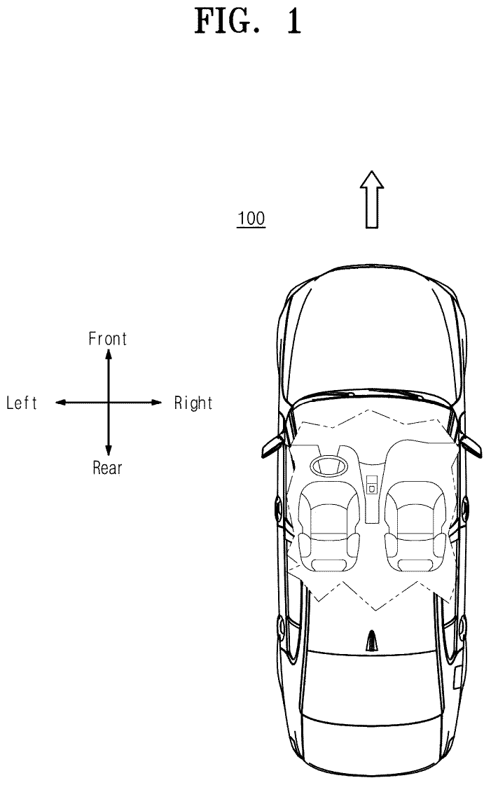

FIG. 1 shows an example of a vehicle according to embodiments. In the present disclosure, for convenience of description, a direction in which a vehicle 100 moves forward will be referred to as a front, and a left direction and a right direction will be identified with respect to the front, in which if the front is a 12 o'clock direction, a 3 o'clock direction or a periphery thereof will be defined as the right direction and a 9 o'clock direction or a periphery thereof will be defined as the left direction. A direction opposite to the front may be a rear. With respect to the center of the vehicle 100, a bottom direction will be referred to as a downward direction and a direction opposite thereto will be referred to as an upward direction. A surface arranged in the front will be referred to as a front surface, a surface arranged in the rear will be referred to as a rear surface, and a surface arranged in a lateral direction will be referred to as a side surface. A side surface in the left direction will be referred to as a left side surface, and a side surface in the right direction will be referred to as a right side surface.

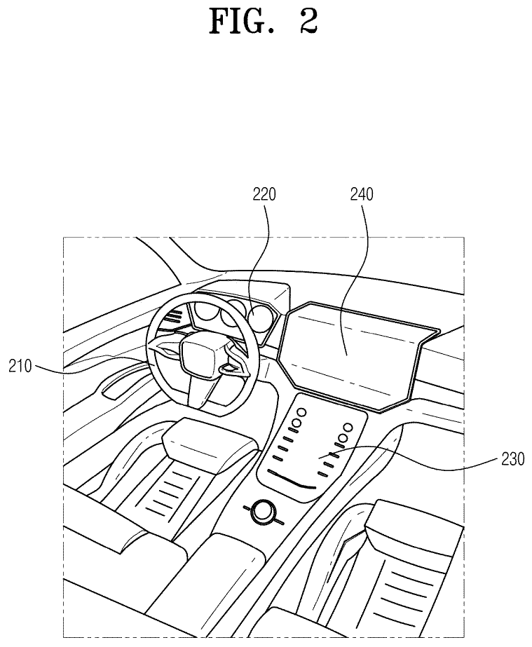

FIG. 2 shows an example of an inner side of a vehicle according to embodiments. In FIG. 2, there is inside the vehicle, a dashboard separating a driver's seat (and front occupant's seat) from an engine room. The dashboard may include a steering wheel 210, a cluster 220, a center fascia 230, a display device 240, etc. Components of the inner side of the vehicle and the dashboard shown in FIG. 2 are examples, and components of the inner side of the vehicle are not limited to the examples.

In FIG. 2, the steering wheel 210 may be configured to manipulate a vehicle direction, and the cluster 220 may display information required for driving, including a speedometer.

The center fascia 230 may be a panel board positioned between the driver's seat and the front occupant's seat in the center of the dashboard. Although not shown, a controller for vehicle control, an air vent, a cup holder, etc., may be installed in the center fascia 230. When the dashboard has a T shape, the center fascia 230 may serve as a wall separating the driver's seat from the front occupant's seat as well as a center console allowing the driver to change a gear and select the driving mode. In the present disclosure, the center fascia 230 does not have a planar shape. For example, the center fascia 230 may include a plurality of curved surfaces.

In the present disclosure, a plurality of display devices may be provided and may be installed at various positions. For example, the display devices may be installed on the dashboard, a room mirror, a rear seat, a front glass, a ceiling, etc.

In the present disclosure, a description will be made of a display 240 installed (or mounted) on the dashboard as an example.

In the present disclosure, the display device 240 may be positioned in the center of the dashboard, especially, at a position perpendicular to the center fascia 230.

In the present disclosure, the display 240 may include a flexible display having the foldable function and/or the sliding function. The flexible display including the foldable function and/or the sliding function will be described in detail later.

According to embodiments, in the display device 240, the display may include a plurality of display areas. In the present disclosure, a description will be made of an embodiment in which the display is divided into three display areas. This is merely an embodiment such that the number of display areas may be greater than or less than 3. According to embodiments, the plurality of display areas may respectively display independent images or two or more areas may display a single image in combination. The display may display one or more soft buttons for state display or control. The one or more soft buttons displayed on the display may have different shapes, sizes, colors, arrangements, positions, functions, etc., according to content displayed on the display or a current vehicle control state. For example, a shape or arrangement of a soft button may be different between when a soft button for adjusting an air conditioning system is displayed and when a soft button for media playback is displayed. That is, the shape of the soft button may be changed variously according to a use condition or need of the display, unlike the physical hard button.

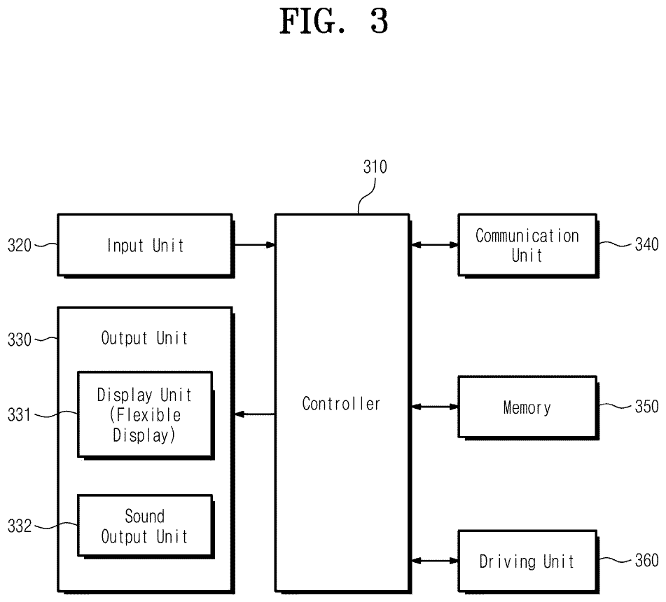

FIG. 3 is a block diagram of an example of a display device according to embodiments.

In FIG. 3, the display device may include a controller 310, an input unit 320, an output unit 330, a communication unit 340, a memory 350, and a driving unit 360. Components of FIG. 3 may correspond to hardware, software, a processor, and/or a combination thereof. In FIG. 3, an execution order of each block may be changed, and some blocks may be omitted and newly added.

According to embodiments, the input unit 320 may receive an operation command of various functions that are executable in the vehicle. The input unit 320 may receive a command for controlling the mode of the display from a user. In the present disclosure, the input unit 320 may include one or more cameras and/or sensors for receiving an image signal, a microphone for receiving an audio signal, and a user input unit (e.g., a touch key, a mechanical key, etc.) for receiving a command from the user. The input unit 320 may also receive information of a destination through texts or voice in execution of a navigation mode.

According to embodiments, the output unit 330 may generate an output related to vision, hearing, etc., and may include a display unit 331 for displaying visual information and a sound output unit 332 for outputting auditory information.

According to embodiments, the display unit 331 may include a flexible display, and visually display information about a function being executed in the vehicle and information input by the user. According to embodiments, the flexible display may be implemented by at least one of a liquid crystal display (LCD), a thin-film transistor liquid-crystal display (TFT LCD), an organic light-emitting diode (OLED), a three-dimensional (3D) display, and an electronic (e)-ink display. In the present disclosure, the display unit 331 may display information required for controlling various devices used in driving of the vehicle or an operation of the vehicle, information required for providing convenience to a vehicle occupant, or entertainment content. In the present disclosure, the entertainment content may include still images, moving images, games, etc. In the present disclosure, texts, images, graphic, etc., displayed on the display will be referred to as visual information.

In the present disclosure, a detailed description of the display unit 331 will be provided later.

According to embodiments, the sound output unit 332 may include a speaker, output the entire information being displayed on the display unit 331 or a part thereof in the form of sound or voice, and output the navigation information, etc., in the form of sound or voice. The sound output unit 332 may output audio of content being displayed on the display unit 331 or output a state of the vehicle, a risk situation, etc., in the form of audio.

According to embodiments, the communication unit 340 may include one or more wireless communication modules that enable wireless communication between the display device 240 and a wireless communication system, the display device 240 and another display device in the same vehicle, between the display device 240 and a display device of another vehicle, or between the display device 240 and an external server. In the present disclosure, the one or more wireless communication modules may support various wireless communications schemes such as wireless fidelity (Wi-Fi), wireless broadband (WiBro), a global system for mobile communication (GSM), code division multiple access (CDMA), wideband code division multiple access (WCDMA), a universal mobile telecommunications system (UMTS), time division multiple access (TDMA), Long Term Evolution (LTE), 4th-Generation (4G), 5th-Generation (5G), 6th-Generation (6G), etc. The communication unit 340 may include a short-range communication module. The short-range communication module may support short-range communication by using at least one of Bluetooth, radio frequency identification (RFID), infrared data association (IrDA), ultra-wideband (UWB), ZigBee, near field communication (NFC), Wi-Fi, Wi-Fi Direct, and wireless universal serial bus (USB). The short-range communication module may form wireless area networks to perform short-range communication between the vehicle and at least one external device. For example, a mobile terminal of the user in the vehicle and the vehicle may be paired with each other automatically or by user's execution of an application.

According to embodiments, the communication unit 340 may further include a global positioning system (GPS) module. The GPS module may obtain the position of the vehicle by using a signal from a GPS satellite, and the obtained position of the vehicle may be used for navigation, etc.

According to embodiments, the communication unit 340 may receive a broadcasting signal and/or broadcasting-related information from an external broadcasting management server through a broadcasting channel. The broadcasting channel may include a satellite channel and/or a terrestrial channel. The broadcasting signal may include not only a TV broadcasting signal, a radio broadcasting signal, and a data broadcasting signal, but also a broadcasting signal in a form where the data broadcasting signal is combined with the TV broadcasting signal or the radio broadcasting signal. The broadcasting-related information may mean information related to a broadcasting channel, a broadcasting program, or a broadcasting service provider. The received broadcasting signal and/or broadcasting-related information may be provided to the user in the vehicle through the display unit 331 and/or the sound output unit 332 of the output unit 330, or may be stored in the memory 350, under control of the controller 310.

According to embodiments, the memory 350 may store data supporting various functions of the display device 240. The memory 350 may store a number of application programs or applications driven by the display device 240, and data and instructions for operations of the display device 240. At least some of the application programs may be downloaded from an external server through wireless communication of the communication unit 340. At least some of the application programs may be present on the display device 240 from the time of shipment for fundamental functions (e.g., call incoming/outgoing functions, a message reception function, a sending function) of the display device 240. The application program may be stored in the memory 350, may be installed on the display device 240, and may be driven to perform an operation (or function) of the display device 240 by means of the controller 310. In the present disclosure, the memory 350 may store map data for implementing the navigation function. The map data may be stored by detail at the time of shipment of the vehicle. The map data may be received from the external device or updated through the communication unit 340.

According to embodiments, the driving unit 360 may fold/unfold a part of the display included in the display unit 331 and/or slide the entire display up/down, under control of the controller 310.

According to embodiments, the controller 310 may control an overall operation of each unit (e.g., the display device 240) in the vehicle as well as an operation related to the application program. The controller 310 may process a signal, data, information, etc., input or output through the above-described components or drive the application program stored in the memory 350 to provide or process information or a function appropriate for the user. The controller 310 may control all or some of the components included in the display device 240 to drive the application program stored in the memory 350.

According to embodiments, the controller 310 may control the driving unit 360 to change a shape and/or a position of the display included in the display unit 331. To this end, the driving unit 360 may include a motor, a hinge, a gear, etc. In some embodiments, the driving unit 360 may be implemented as hardware and be referred to as a drive assembly.

The controller 310 may control the display unit 331 to flexibly use the display according to a mode.

According to embodiments, the controller 310 may perform a function of an electronic control unit (ECU) or a function of an advanced driver assistance system (ADAS), or both functions. In the present disclosure, the controller 310 may be implemented as hardware using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

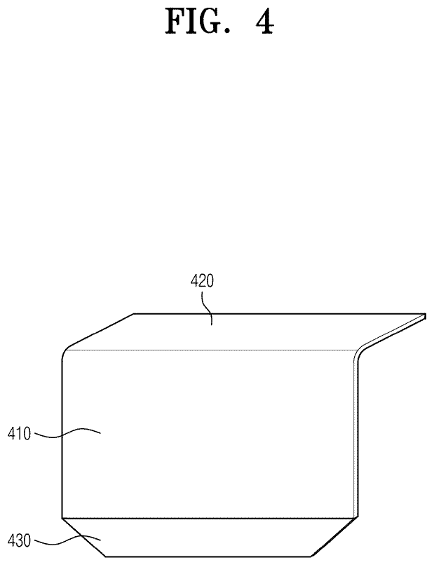

FIG. 4 shows an example of a display of a display device according to embodiments. The display device 240 may include the display unit 331 which may include a flexible display.

According to embodiments, the display may include a plurality of display areas. In the present disclosure, a description will be made of an embodiment in which the display is divided into three display areas. In the present disclosure, for convenience of a description, three display areas may include a first area 410, a second area 420, and a third area 430.

In the present disclosure, in an embodiment, the first area 410 may be positioned between the second area 420 and the third area 430, and may be a main area that maintains a planar state at all times. The second area 420 and the third area 430 may be referred to as sub areas in which the display is foldable, i.e., is foldable or unfoldable at a specific angle.

According to embodiments, the first area 410 to the third area 430 may be implemented as separate touch screens or a single touch screen.

In the present disclosure, a surface of the first area 410 on which a touch screen is visible may be interpreted as a front surface, and a surface opposite to the front surface may be interpreted as a rear surface.

In the present disclosure, the first area 410 to the third area 430 may be arranged on the front surface, and especially, the second area 420 may be positioned above the first area 410 and the third area 430 may be positioned under the first area 410.

According to embodiments, the first area 410 to the third area 430 may have the same size or different sizes. In an embodiment of the present disclosure, among the first area 410 to the third area 430, the first area 410 has the largest size. The second area 420 and the third area 430 may have the same size or different sizes.

In the present disclosure, a state of a part of the display being bent at a specific angle may be referred to as a folded state, and a state of the part of the display being unfolded may be referred to as an unfolded state. In the present disclosure, the second area 420 and/or the third area 430 may be folded or unfolded at a specific angle.

In the present disclosure, the unfolded state may mean a state where the first area 410 and the second area 420 form an angle of 180 degrees (or about 180 degrees) or a state where the first area 410 to the third area 430 all form an angle of 180 degrees (or about 180 degrees). The unfolded state may also mean a state where the first area 410 and the second area 420 are arranged substantially flat or a state where the first area 410 to the third area 430 all are arranged substantially flat.

In the present disclosure, the folded state may mean a state where the second area 420 is folded at a specific angle with respect to the first area 410 and/or the third area 430 is folded at a specific angle with respect to the first area 410. An angle at which the second area 420 is bent and an angle at which the third area 430 is bent may be the same as or different from each other.

In the present disclosure, the second area 420 may be folded inwardly or outwardly with respect to the first area 410. The folding angle of the second area 420 may be fixed or manually determined by the user or may be automatically determined by determination of the controller 310. On the other hand, in an embodiment, the third area 430 may be folded inwardly with respect to the first area 410. The folding angle of the third area 430 may be fixed or manually determined by the user or may be automatically determined by determination of the controller 310.

In the present disclosure, outward folding may mean a state in which the second area 420 is bent outward to direct the touch screen of the first area 410 and the touch screen of the second area 420 opposite to each other. Inward folding may mean a state in which the second area 420 is folded at a specific angle to direct the touch screen of the first area 410 and the touch screen of the second area 420 inwardly (i.e., to the front surface) or a state in which the third area 430 is folded at a specific angle to direct the touch screen of the first area 410 and the touch screen of the third area 430 inwardly (i.e., the front surface).

According to embodiments, the display unit 331 may use the first area 410 to the third area 430 as independent screens according to a mode under control of the controller 310, or may combine at least two areas and use the combined area as a single screen. For example, all of the first area 410, the second area 420, and the third area 430 may be combined to form a single large screen.

According to embodiments, the display unit 331 may include a plurality of modes.

In the present disclosure, a basic mode (or an off mode) may refer to a mode when the display is in an off state, and an operation mode may refer to a mode when the display is in an on state.

In the present disclosure, when a display is in the off state, a vehicle's engine is not running or the vehicle's engine is running, but the display (or a display device) is turned off. When the vehicle engine is running, the off mode may be selected by the user.

In an embodiment, the operation mode may be divided into three modes. In the present disclosure, the three modes will be referred to as a first mode (or a mode A), a second mode (a mode B), and a third mode (a mode C). In the present disclosure, the number of modes is an example, and the present disclosure is not limited thereto.

In the present disclosure, the driving unit 360 may fold or unfold the second area 420 and/or the third area 430 at a specific angle according to a mode. The driving unit 360 may vertically slide the entire display according to a mode.

According to embodiments, the driving unit 360 may include a hinge that facilitates folding/unfolding of the second area 420 and/or the third area 430. In an embodiment, the hinge may be arranged between the first area 410 and the second area 420 and between the first area 410 and the third area 430 such that the second area 420 and/or the third area 430 maintains a set shape or a folding angle. That is, the first area 410 and the second area 420, and the first area 410 and the third area 430 may be connected to each other by the hinge.

According to embodiments, in the basic mode or the off state of the second area 420 (i.e., nothing is displayed), the second area 420 may be folded inwardly (i.e., to the front surface) or outwardly (i.e., to the rear surface), with respect to the first area 410, to ensure visibility of the driver in the driver's seat and/or the front occupant's seat of the vehicle.

According to a folding direction of the second area 420, i.e., whether the second area 420 is folded outwardly (i.e., out) or inwardly, the display may have an S shape or a C shape in the basic mode or the off state of the second area 420. In the present disclosure, outward folding will be referred to as out-folding, and inward folding will be referred to as in-folding.

In an embodiment of the present disclosure, the second area 420 may be in the folded state in the first mode and in the unfolded state in the second mode and the third mode.

In an embodiment of the present disclosure, the third area 430 may be in the folded state in the first mode and the second mode and in the unfolded state in the third mode.

To sum up, both the second area 420 and the third area 430 are in the folded state in the first mode, the second area 420 may be in the unfolded state and the third area 430 may be in the folded state, in the second mode, and both the second area 420 and the third area 430 may be in the unfolded state in the third mode. In other words, in an embodiment of the present disclosure, the mode differs with the shape of the display.

According to embodiments, when the second area 420 is in the folded state, nothing (e.g., a black screen or a screen having a color such as a dashboard) may be displayed in the second area 420, or basic information, e.g., a welcome message, artificial intelligence (AI) communication, weather, current time, emergency information, interior images, etc., may be displayed. The above-listed basic information may be an example, and in the present disclosure, the basic information may be added, changed, or removed, and thus is not limited to the above-listed information.

According to embodiments, when the third area 430 is in the folded state, one or more soft buttons for performing specific functions may be displayed in the third area 430. The soft button may have an icon form and may have a graphic form indicating a function thereof. Alternatively, the soft buttons may be grouped in association with a specific function. According to the number of soft buttons, arrangements of the soft buttons, etc., the third area 430 may include one or more pages. In this case, selection of an arrow, an icon indicating the next page, etc., may allow movement to the next page. In the present disclosure, the soft button may be used as the same meaning as a virtual button.

For example, when the third area 430 is in the folded state, the third area 430 may include a vehicle control area (or an air conditioning control area) related to an air conditioner, a heater, etc., and one or more soft buttons for performing functions related to air conditioning may be arranged in the vehicle control area. For example, the user may adjust a wind direction, a wind volume, a temperature, etc., by touching one or more buttons in the vehicle control area. In another embodiment, a vehicle control button and a soft button for volume control, seat adjustment, etc., may be further displayed in the third area 430.

In another example, when the third area 430 is in the unfolded state, i.e., in the third mode (i.e., an entertainment mode), a content control button for entertainment may be displayed in the third area 430.

In the present disclosure, the number, functions, arranged positions, etc., of soft buttons displayed in the third area 430 may be changed, added, or deleted.

According to embodiments, in the first mode, the first area 410 to the third area 430 may operate separately. That is, navigation information, image contents, contents that may be provided on a large screen, etc., may be displayed in the first area 410, and nothing (e.g., a black screen or a screen in the same color as a dashboard) or basic information may be displayed in the second area 420 in the folded state. In the third area 430, in the folded state, one or more soft buttons for vehicle control, air conditioning, etc., may be displayed. The basic information may include a welcome message, weather, current time, emergency information, etc. The above-listed basic information may be an example, and in the present disclosure, the basic information may be added, changed, or removed, and thus is not limited to the above-listed information.

According to embodiments, in the second mode, as the second area 420 is unfolded, the first area 410 and the second area 420 may be combined with each other as a single display area. The combined display area may operate separately from the third area 430. That is, one image, e.g., navigation information, image contents, contents that may be provided on a large screen, etc., may be extended and displayed in the combined display area, and one or more soft buttons for vehicle control, air conditioning, etc., may be displayed in the third area 430 in the folded state. In another embodiment, in the second mode, as the second area 420 is unfolded, the first area 410 and the second area 420 are arranged in a flat state, but the first area 410 and the second area 420 may operate separately. In other words, the first area 410 to the third area 430 may operate separately. In this case, the navigation information, the image contents, the contents that may be provided on a large screen, etc., may be displayed in the first area 410, and the basic information may be displayed in the second area 420.

According to embodiments, in the third mode, as the second area 420 and the third area 430 are unfolded, the display may slide upwardly. In this case, the first area 410 to the third area 430 may be combined as a single display area. Then, contents may be displayed in the combined display area (i.e., a full screen). In the present disclosure, the contents may include a still image, a moving image, a TV program, a game, etc. In the third area 430, soft buttons for controlling playback of contents or displaying a content state may be displayed. In the present disclosure, a third mode in which the first area 410 to the third area 430 may be combined to form a single large screen (i.e., a full screen) and contents are displayed through the large screen will be referred to as an entertainment mode.

In the third mode 430, as the display including the first area 410 to the third area 430 slides upwardly, an area hidden by the third area 430 may be exposed, and in the present disclosure, this area will be referred to as a hidden area or a hidden button area.

In an embodiment, in the present disclosure, the hidden area may include at least one hard button. The hard button may mean a button having fixed position and size. In the present disclosure, the hard button of the hidden area may be referred to as a physical button.

In another embodiment, the hidden area may be provided in the form of a display in the present disclosure. The display in the hidden area may display at least one soft button to enable the specific function of the vehicle and/or the specific function of the display to be executed. The soft button may refer to a button provided as a touch type on the screen of the display. The shape of the soft button in the hidden area may be changed variously according to a use condition or need of the display, unlike the hard button. When the hidden area is provided in the form of a display, for convenience of description, the display having the foldable function will be referred to as a first display and the display in the hidden area will be referred to as a second display, in the present disclosure.

In this case, a specific function of the vehicle and/or a specific function of the display may be executed by at least one button (e.g., a hard button or a soft button) of the hidden area.

In an embodiment of the present disclosure, at least one button of the hidden area may include a button for executing at least one soft button among soft buttons displayed in the third area 430 in the first mode and the second mode. For example, at least one buttons of the hidden area may serve as soft buttons of the vehicle control area displayed in the third area 430 in the first mode and the second mode. That is, some or all of one or more soft buttons displayed in the third area 430 in the first mode and the second mode may disappear from the third area 430 to display contents in the third mode, and in this case, a function may be replaced using the at least one button of the hidden area.

In the present disclosure, some of buttons of the hidden button area may be buttons for new functions not related to functions of the one or more soft buttons displayed in the third area 430 in the first mode and the second mode.

In the present disclosure, selection of the first mode, the second mode, and the third mode may be performed manually by the user, and may be performed automatically by the controller 310 according to a state of the vehicle. Alternatively, according to user's selection, a mode may he changed in the controller 310.

For example, when the display in the off mode, the first mode may be selected by control by the controller 310, and when the vehicle is in a normal driving mode, the first mode or the second mode may be selected by control by the controller 310. The controller 310 may control the third mode to be selected in a parking, stopping, or autonomous driving mode.

As such, in the present disclosure, the third mode may be referred to as an entertainment mode, and during parking, autonomous driving, and stopping, the second area 420 and the third area 430 may be unfolded and at the same time, the display including the first area 410 to the third area 430 may rise upwardly through sliding, thus changing the shape and position of the display. That is, as the second area 420 and the third area 430 are unfolded, the display area may be extended to the full screen (i.e., a single large screen), and as the display rises upwardly, the hidden area may appear (or may be exposed).

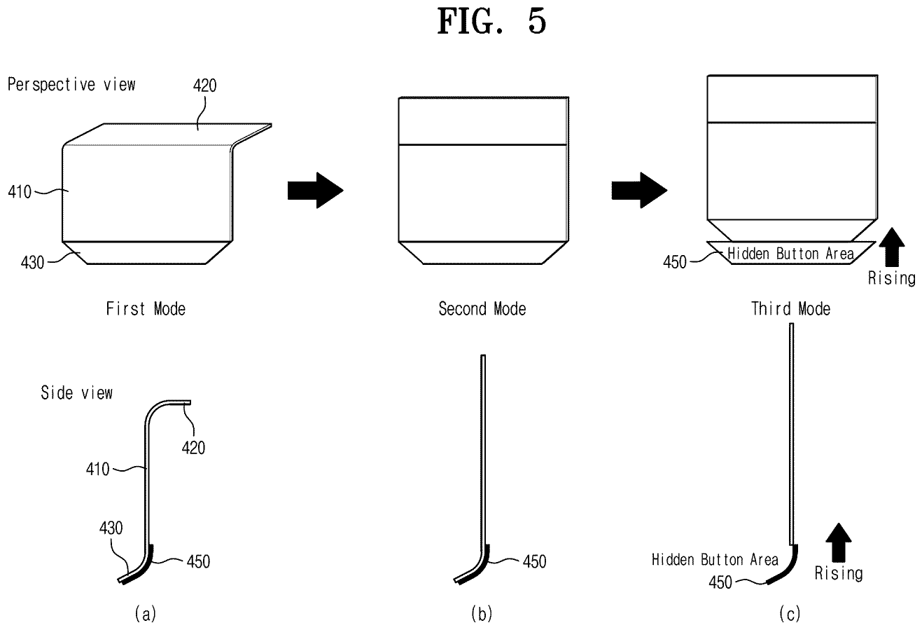

FIG. 5(a) to FIG. 5(c) show examples of shape (or form) change and position change of a display in the first to third modes. In the present disclosure, to avoid redundant description, some description may be omitted from FIG. 5(a) to FIG. 5(c). Therefore, the description omitted from FIG. 5(a) to FIG. 5(c) will refer to the description of FIG. 2 to FIG. 4.

In FIG. 5(a) to FIG. 5(c), an upper side shows perspective views of the first area 410 to the third area 430 of the display having a shape changing with a mode, and a lower side shows side views of the first area 410 to the third area 430 of the display having the shape changing with the mode.

More specifically, FIG. 5(a) shows an example in the first mode in which both the second area 420 and the third area 430 are in the folded state with respect to the first area 410 and a hidden area 450 is hidden by the third area 430. That is, as the third area 430 hides the hidden area 450, the user in the driver's seat and/or the front occupant's seat of the vehicle may not see the hidden area 450 due to the third area 430. An angle at which the second area 420 is folded and an angle at which the third area 430 is folded may be the same as or different from each other.

FIG. 5(b) shows an example in the first mode in which the second area 420 is in the unfolded state with respect to the first area 410, the third area 430 is in the folded state, and the hidden area 450 is hidden by the third area 430. That is, also in the second mode, as the third area 430 hides the hidden area 450, the user in the driver's seat and/or the front occupant's seat of the vehicle may not see the hidden area 450 due to the third area 430. In this case, the first area 410 and the second area 420 may be arranged substantially flat to form a single display area (i.e., a display screen) or separate display areas.

FIG. 5(c) shows an example in the third mode in which both the second area 420 and the third area 430 are in the unfolded state with respect to the first area 410, and the display including the first area 410 to the third area 430 slides upwardly. In this case, a sliding distance may be fixed to a specific value or may be selected by the user. That is, as the display rises upwardly through sliding, the hidden area 450 hidden by the third area 430 may be exposed. In other words, the user in the driver's seat and/or the front occupant's seat of the vehicle may see the hidden area 450 hidden by the third area 430. In this case, the third area 410 to the third area 430 may be arranged substantially flat to form a single display area (i.e., the display screen). That is, in the third mode, a large screen may be formed.

In the first mode and the second mode according to the present disclosure, the shape (or form) of the display may be changed, but in the third mode, the shape and the position of the display may be changed.

As described above, in the first mode or the second mode, the first area 410 may correspond to a main display area and has a larger screen than the second area 420, thereby displaying effective information (e.g., a navigation screen during driving, moving-image contents during parking) by using a large screen. As the second area 420 has a smaller screen than the first area 410, the second area 420 may display a matter related to intensive information and the first area 410 may display, in detail, information that may not be fully displayed in the second area 420.

In the present disclosure, when the first area 410 and the second area 420 separately operate in the flexible display structure, detailed information displayed in the first area 410 may be simplified so as to be displayed as brief information in the second area 420, or the brief information displayed in the second area 420 may be specified so as to be displayed as detailed information in the first area 410. The second area 420 may be in the folded state or the unfolded state.

In the present disclosure, a process of simplifying the detailed information displayed in the first area 410 and displaying the brief information in the second area 420 or a process of specifying the brief information displayed in the second area 420 and displaying the detailed information in the first area 410 may be performed by a selection of the user (e.g., a driver or an occupant in a front occupant's seat or may be performed automatically under control of the controller 310 upon occurrence of an event.

In the present disclosure, the user's selection may be made by a gesture such as screen touch or flicking.

For example, the user may make a gesture to slide the screen upwardly while touching the screen with two fingers so as to simplify the detailed information of the first area 410 and display the brief information in the second area 420, and may make a gesture to slide the screen downwardly while touching the screen with the two fingers so as to specify the brief information of the second area 420 and display the detailed information in the first area 410. In this case, a gesture to request information conversion using the two fingers may be an example, and a gesture pattern, the number of fingers, etc., may be various.

In another example, a soft button for conversion may be displayed in at least one of the first area 410 and the second area 420, and upon a user's touch on the soft button (i.e., the touch on the screen), the detailed information of the first area 410 may be simplified and displayed in the second area 420 or the brief information of the second area 420 may be specified and displayed as the detailed information in the first area 410. That is, the soft button for conversion may operate as a toggle button. In another example, by adding the soft button for conversion to each area, each function may be performed upon a touch on the corresponding soft button. For example, when the soft button for conversion displayed in the first area 410 is touched (i.e., pressed), the detailed information of the first area 410 may be simplified and displayed in the second area 420. On the other hand, when the soft button for conversion displayed in the second area 420 is touched (i.e., pressed), the brief information of the second area 420 may be specified and displayed in the first area 410.

Meanwhile, in the present disclosure, upon occurrence of an event, an event message including a text indicating the occurring event may be displayed in one of the first area 410 and the second area 420 under control of the controller 310.

In the present disclosure, the event may be any event that may occur during driving such as a warning light displayed on a cluster, a flat tire, etc. In the present disclosure, the cluster may be referred to as an instrument panel, a dashboard, etc.

In the present disclosure, the warning light displayed on the cluster of the vehicle may immediately inform the driver of abnormality of the vehicle or a situation requiring attention. According to embodiments, the warning light displayed on the cluster may include a check engine light, a battery warning light, an oil pressure warning light, a tire pressure monitoring system (TPMS), a brake warning light, an anti-lock braking system (ABS) light, a coolant temperature warning light, an airbag warning light, a fuel warning light, and a seatbelt warning light. This is merely an embodiment, and the warning light may be added or deleted.

In particular, in the present disclosure, upon occurrence of an event in the folded state of the second area 420, the second area 420 may be unfolded and a message including a text indicating the occurring event may be displayed in the second area 420.

In an embodiment, when a warning light is displayed on the cluster of the vehicle, a message including a text indicating the warning light may be displayed in the second area 420 of the flexible display. That is, in the second area 420, description information about a warning light icon provided on the cluster during driving may be displayed in the second area 420. In the folded state of the second area 420, the controller 310 may control the display unit 331 and the driving unit 360 to unfold the second area 420 and display a message in the unfolded second area 420.

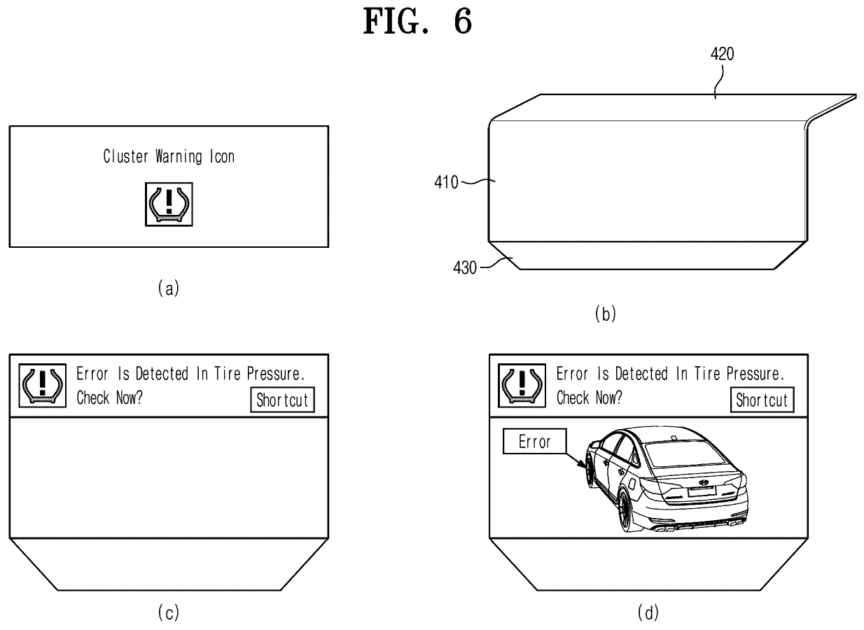

FIG. 6(a) to FIG. 6(d) show an example showing an event displayed in a second area in case of occurrence of the event, according to embodiments.

For example, when the tire pressure monitoring system is displayed on the cluster as shown in FIG. 6(a), the controller 310 may determine whether the second area 420 of the flexible display is folded. When the second area 420 is folded as shown in FIG. 6(b), the second area 420 may be unfolded through the driving unit 360 and then a message related to a warning light may be displayed as shown in FIG. 6(c). In this case, a warning light having the same shape (i.e., an icon) as the warning light displayed on the cluster may be displayed together with a text. For example, a message related to a warning light such as “Error in tire pressure. Check now?” may be displayed. To check an error in a tire pressure, a soft button (or a menu) like “Ok” or “Shortcut” may be displayed together.

Upon selection of “Ok” or “Shortcut” by the user, detailed information for checking a state of the tire pressure of the vehicle may be displayed in the first area 410 as shown in FIG. 6(d). Herein, the detailed information may be displayed as an image, a text, etc.

In this way, the user may recognize a meaning, an emergency level, a countermeasure, etc., of the warning light without needing to search a vehicle's owner's manual (i.e., manual), the Internet, etc., when the user does not know the meaning of the warning light.

When the message related to the warning light is displayed in the second area 420 as shown in FIG. 6(c) and the user selects “Ok” or “Shortcut”, if nothing is displayed in the first area 410 (e.g., the black screen or the screen having the same color as the dashboard), a warning light message may be maintained as shown in FIG. 6(d) or may be changed to the basic information in the second area 420.

Meanwhile, when the warning light message is displayed in the second area 420 as shown in FIG. 6(c), detailed information indicating the state of the tire pressure of the vehicle may be displayed in the first area 410 as shown in FIG. 6(d) through a gesture like a user's screen touch or flicking instead of the soft button “Ok” or “Shortcut”. For example, when the user makes a gesture to slide the screen downwardly while touching the screen with two fingers, detailed information related to the tire pressure monitoring system message of the second area 420 may be displayed in the first area 410 as shown in FIG. 6(d). In this case, a gesture pattern is an example and the foregoing function may be performed with another gesture pattern.

In another example, when the warning light message is displayed in the second area 420 as shown in FIG. 6(c) and the user selects “Ok” or “Shortcut”, if information such as navigation information or image contents is displayed in the first area 410, information conversion may be performed between the first area 410 and the second area 420. That is, detailed information related to the warning light of the second area 420 may be displayed in the first area 410, and brief information related to navigation or contents of the first area 410 may be displayed in the second area 420. Also in this case, the user may make a gesture like flicking instead of a soft button like “Shortcut”.

In this case, the information conversion (or association between displays) may be made automatically or a user's selection.

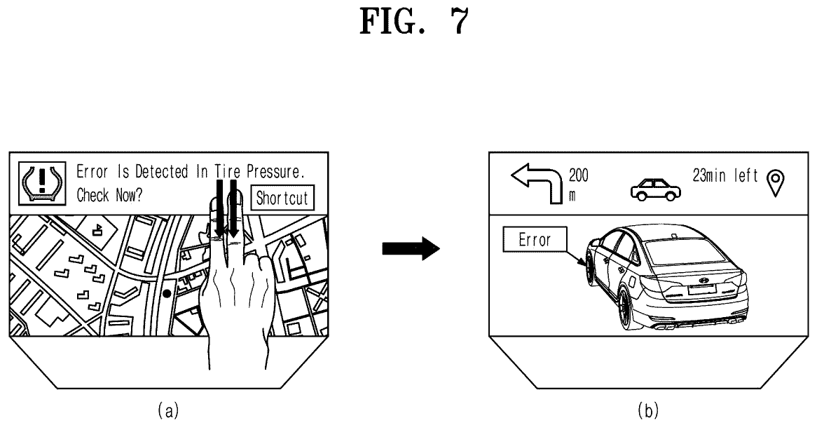

FIG. 7(a) and FIG. 7(b) show an example of information conversion according to embodiments. In particular, FIG. 7(a) and FIG. 7(b) show an example for converting brief information of the second area 420 into detailed information and displaying the detailed information in the first area 410.

For example, as shown in FIG. 7(a), when the tire pressure monitoring system message is displayed in the second area 420 and the user selects “Shortcut”, if the navigation information is displayed in the first area 410, then detailed information related to the tire pressure monitoring system message of the second area 420 may be displayed in the first area 410 and brief information about the navigation information of the first area 410 may be displayed in the second area 420 as shown in FIG. 7(b).

In another embodiment of the present disclosure, as shown in FIG. 7(a), when the first area 410 and the second area 420 respectively display information while operating as separate screens (i.e., in the first mode or the second mode), the user may select information conversion through a gesture such as a screen touch or flicking. When the vehicle has a motion recognition function, the user may perform a function by making a preset motion gesture without touching the screen.

For example, when the user makes a gesture to slide the screen downwardly while touching the screen with two fingers, detailed information related to the tire pressure monitoring system message of the second area 420 may be displayed in the first area 410 and brief information about the navigation information of the first area 410 may be displayed in the second area 420, as shown in FIG. 7(b).

In this case, a gesture pattern is an example and the foregoing function may be performed with another gesture pattern.

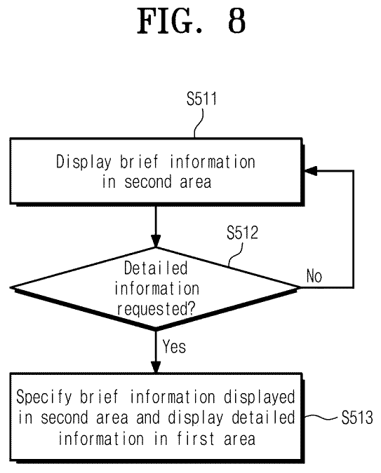

FIG. 8 is a flowchart of an example of an information conversion method according to embodiments. That is, when brief information is displayed in the second area 420 as shown in FIG. 6(c) or FIG. 7(a) in operation S511, the user may press a button (e.g., a shortcut) provided in the second area 420 or make a specific gesture (e.g., a gesture for downward pushing using two fingers, etc.) to request detailed information if the user needs the detailed information, in operation S512. Then, the brief information of the second area 420 may be specified and displayed as the detailed information in the first area 410, as shown in FIG. 6(d) or FIG. 7(b), in operation S513. The detailed information displayed in the first area 410 may be converted into the brief information and displayed in the second area 420.

As such, to identify more detailed information by sending information of the second area 420 to a large screen like the first area 410, if the user may press a button (e.g., a shortcut) provided in the second area 420 or make a specific gesture (e.g., flicking to a corresponding screen using two fingers, etc.), the brief information of the second area 420 may be specified and displayed in the first area 410.

In another embodiment of the present disclosure, the second area 420 may be used for simple setting, etc., of setting information displayed in the first area 410.

That is, as detailed information may be mainly provided in the first area 410, the user may be provided with a function that may be simply manipulated as information required during driving. The information of the first area 410 may be moved to the second area 420 through a user's screen touch or specific gesture (e.g., flicking to a corresponding screen using two fingers, etc.), and in this case, may be converted into simple information (i.e., brief information) which may be displayed in the second area 420. In this situation, a setting item of the first area 410 moving to the second area 420 may be maintained and if the user swipes (i.e., pushes) down while touching the screen with the two fingers, on/off setting displayed in the second area 420 may disappear. When the vehicle has a motion recognition function, the user may perform a function by making a preset motion gesture without touching the screen.

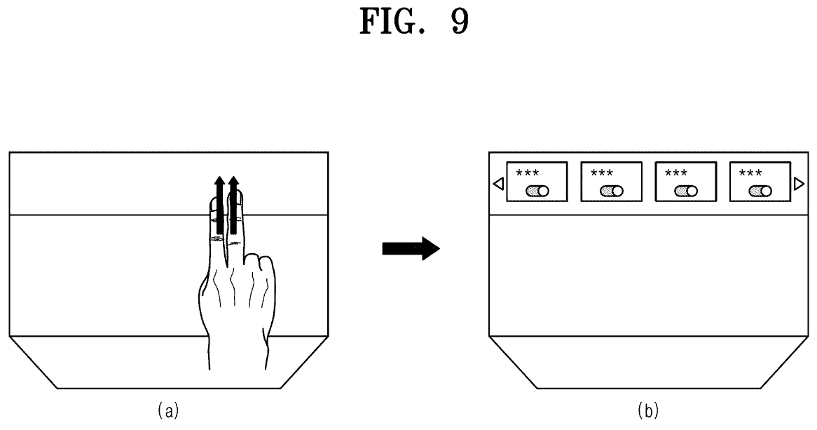

FIG. 9(a) and FIG. 9(b) show another example of information conversion according to embodiments. In particular, FIG. 9(a) and FIG. 9(b) show an example for converting detailed information of the first area 410 into brief information and displaying the brief information in the second area 420. Herein, in an embodiment, the brief information may include information that may be set by on/off.

FIG. 9(a) shows one of user's selection methods to display the detailed information of the first area 410 as the brief information in the second area 420. That is, when the user swipes (pushes) up while touching the screen with the two fingers as shown in FIG. 9(a), information displayed in the first area 410 may be simplified and displayed in the second area 420 as shown in FIG. 9(b). In this case, in an embodiment, nothing is displayed in the first area 410.

According to embodiments, brief information displayed in the second area 420 may include one or more items that may be on/off set. That is, the brief information may correspond to on/off-settable information out of the setting information displayed in the first area 410.

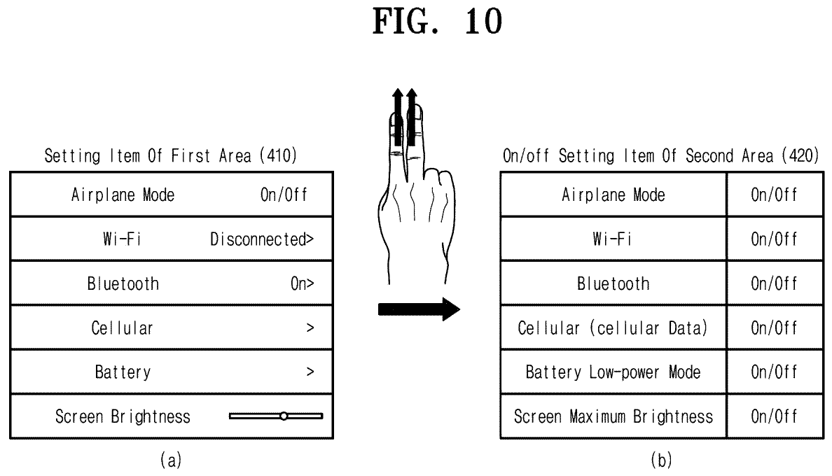

FIG. 10(a) shows examples of setting items of a first area according to embodiments, and FIG. 10(b) shows examples of on/off setting items of a second area.

As shown in FIG. 10(a), the setting items of the first area may include items that may be set merely by display on/off, items that may be set through detailed setting, or items that may be set in detail through a progress bar, etc.

For example, among the setting items of FIG. 10(a), an airplane mode may be on/off. Items such as Wi-Fi, Bluetooth, cellular, battery, etc., may be set through detailed setting. An item like screen brightness may be set in detail through the progress bar (i.e., position-set in the form of a line).

FIG. 10(b) shows examples of on/off setting items that may be displayed in the second area 420. That is, the items that may be set through detailed setting, such as Wi-Fi, Bluetooth, cellular, battery, etc., may be simplified so as to be on/off-set and may be displayed in the second area 420. The items that may be set in detail through the progress bar may also be simplified so as to be on/off-set and may be displayed in the second area 420.

According to embodiments, the user may select or touch a desired on/off setting item from among on/off setting items displayed in the second area 420 as shown in FIG. 10(b), thereby changing the corresponding on/off setting items from on to off or from off to on. For example, the user may change the on/off setting item to on or off by touching a screen's maximum brightness.

The on/off setting items that may be displayed in the second area 420 of FIG. 10(b) may be examples, and may be added, modified, or deleted.

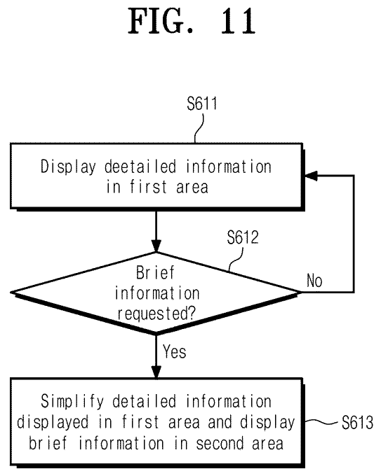

FIG. 11 is a flowchart of another example of an information conversion method according to embodiments. That is, when detailed information is displayed in the first area 410 as shown in FIG. 10(a) in operation S611, the user may press a button (e.g., a shortcut) provided in the first area 410 or make a specific gesture (e.g., a gesture for upward pushing to a corresponding screen using two fingers, etc.) to request brief information if the user needs the brief information, in operation S612. Then, the detailed information of the first area 410 may be simplified and displayed as the brief information as shown in FIG. 9(b) or FIG. 10(b), in operation S613.

For example, items that may be set through the detailed setting, such as Wi-Fi, Bluetooth, cellular, battery, etc., as shown in FIG. 10(a) may be simplified so as to be on/off-set and displayed in the second area 420 as shown in FIG. 10(b).

As such, in the present disclosure, the on/off-settable items may be displayed together in the second area 420, thereby allowing the user's manipulation within a short time and thus lengthening a time for which the user may concentrate on driving. Through a specific input (a gesture or a touch input) between the first area 410 and the second area 420, the user may manipulate and may be provided with information while concentrating on driving.

In another embodiment of the present disclosure, the first area 410 and the second area 420 may be extended (or combined) into a single large screen, and contents reproduced in the first area 410 may be extended and reproduced on a large screen.

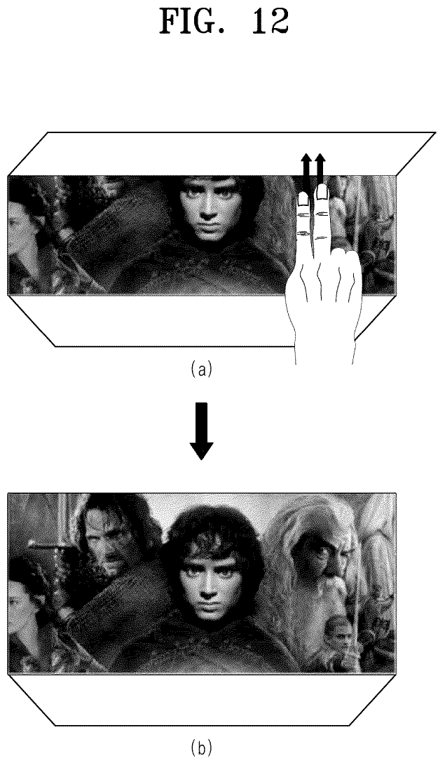

FIG. 12(a) and 12(b) show another example of information conversion according to embodiments.

For example, when the second area 420 is in the folded state and the image contents are reproduced in the first area 410, as shown in FIG. 12(a), if the user makes a gesture to push upwardly while touching the screen with two fingers, then the second area 420 may be unfolded such that the first area 410 and the second area 420 may be combined into one display area and the image contents displayed in the first area 410 may be extended and displayed in the combined display area, as shown in FIG. 12(b). This may be identically applied when the navigation information is displayed in the first area 410.

FIG. 12(a) and FIG. 12(b) may be applied when the image contents or the navigation information is displayed in the first area 410 in a situation where any information is not provided in the second area 420. In another example, this may be applied when an image is displayed in the first area 410 in a situation where information is provided in the second area 420. The image may be a moving image or a still image.

That is, when the image contents are provided in the first area 410, the second area 420 may be unfolded through a preset gesture such that the first area 410 and the second area 420 may be extended to a single screen and the image contents may be provided on the extended screen.

In another embodiment of the present disclosure, the foregoing function may be applied in the unfolded state of the second area 420. For example, when the second area 420 is in the unfolded state and the image contents are reproduced in the first area 410, if the user makes a gesture to push upwardly while touching the screen with the two fingers, then the first area 410 and the second area 420 may be combined into a single display area and the image contents displayed in the first area 410 may be extended and displayed in the combined display area. This may be identically applied when the navigation information is displayed in the first area 410.

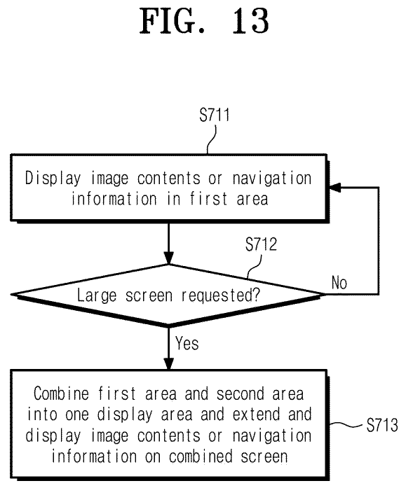

FIG. 13 is a flowchart of another example of an information conversion method according to embodiments. That is, when video contents are displayed in the first area 410 as shown in FIG. 12(a) in operation S711, the user may press a button (e.g., a shortcut) provided in the first area 410 or make a specific gesture (e.g., a gesture for upward pushing to a corresponding screen using two fingers, etc.) to request a large screen if the user needs the large screen, in operation S712. Then, the first area 410 and the second area 420 may be combined into a single large screen, and the video contents may be extended to the large screen and may be displayed, in operation S713. FIG. 13 is identically applicable when the navigation information is displayed in the first area 410.

The vehicle control apparatus and the control method thereof according to embodiments may improve usability of the display by changing the shape or position of the display according to a mode.

The vehicle control apparatus and the control method thereof according to embodiments may provide the user with convenience by appropriately controlling the size of the display area according to a mode.

The vehicle control apparatus and the control method thereof according to embodiments may conveniently change the size of the screen to be displayed and save the space, by folding or unfolding a part of the display according to a purpose for use. That is, the view of the driver and/or the occupant may not be obstructed by folding a part of the display according to a purpose for use, or the display with the large screen may be implemented by entirely unfolding the display.

The vehicle control apparatus and the control method thereof according to embodiments may expose the hidden area hidden by a part of the display by raising the display through sliding according to a mode for conversion into the entertainment mode, such that a part of the vehicle control function disappearing from the screen may be performed using the buttons of the hidden area.

The vehicle control apparatus and the control method thereof according to embodiments may organizationally provide information by using a main display area and a sub display area located above the main display area, thereby allowing the user to easily understand information and to quickly check and manipulate information even for short moment during driving.

The vehicle control apparatus and the control method thereof according to embodiments may display, in the sub display area of the flexible display, an event-related message indicating occurrence of an event upon occurrence of the event during driving, thereby allowing the user to easily recognize and deal with occurrence of the event.

The vehicle control apparatus and the control method thereof according to embodiments may unfold the sub display area and an event-related message indicating occurrence of an event in the unfolded sub display area if the sub display area is in the folded state upon occurrence of the event, thereby allowing the user to clearly identify occurrence of the event.

In addition to the technical effects explicitly mentioned above, effects that are obvious to those of ordinary skill in the art may also be inferred from the entire description of the present specification.

Each part, module or unit described above may be software, processor or hardware parts that execute sequential execution processes stored in a memory (or storage unit). Each operation described in the foregoing embodiment may be performed by processor, software, and hardware parts. Each module/block/unit described in the above-described embodiment may operate as a processor, software, or hardware. Additionally, the methods presented in the embodiments may be implemented as code. This code may be written to a processor-readable storage medium and may therefore be read by a processor provided by the apparatus.

Although the present specification has been described for each drawing separately for convenience of a description, it is also possible to design a new embodiment by combining the embodiments described in each drawing. In addition, it is also within the scope of the present disclosure to design a computer-readable recording medium having recorded thereon a program for executing the previously described embodiments, as required by those of ordinary skill in the art.

The apparatus and method according to the present disclosure are not limitedly applied to the configuration and method of the embodiments described above, but the embodiments may be configured by selectively combining all or part of the embodiments such that various modifications can be made.

In the present disclosure, terms such as first, second, etc. may be used to describe various components of the present disclosure. However, various components according to the present disclosure should not be limited in interpretation by the foregoing terms. These terms are only used to distinguish one component from another. For example, a first user input signal may be referred to as a second user input signal. Similarly, the second user input signal may be referred to as the first user input signal. Any use of these terms should be construed as not departing from the scope of the various embodiments. Although both the first user input signal and the second user input signal are user input signals, they do not mean the same user input signals unless the context clearly indicates otherwise.

The terminology used to describe the present disclosure is for the purpose of describing particular embodiments only and is not intended to be limiting of the embodiments. As used in the description of the embodiments and in the claims, the singular is intended to include the plural unless the context clearly dictates otherwise. Additionally, the expression “and/or” is used to mean all possible combinations of terms. The expression “include” describes the presence of features, numbers, operations, elements, and/or components, but does not imply the exclusion of additional features, numbers, operations, elements, and/or components. Conditional expressions such as in case that, when, etc., used to describe the present disclosure are not to be interpreted as being limited to only optional cases. When certain conditions are satisfied, it is intended that a related operation be performed in response to certain conditions, or that a related definition be interpreted.

What is claimed is:

1. A vehicle control apparatus comprising:
a vehicle body; and
a display device provided in the vehicle body,
wherein the display device comprises:
a display configured to display visual information;
a drive assembly configured to change at least one of a shape of the display and a position of the display; and
a controller configured to control the display and the drive assembly, and
wherein a display area of the display is divided into a first area, a second area, and a third area arranged on a same surface,
the second area is positioned above the first area, and the third area is positioned under the first area,
at least one of the second area and the third area is folded or unfolded at a specific angle by the drive assembly, and
the controller is further configured to control brief information displayed in the second area to be specified and displayed as detailed information in the first area or control detailed information displayed in the first area to be simplified and displayed as brief information in the second area.

2. The vehicle control apparatus of claim 1, wherein the controller is further configured to control a message comprising a text indicating an event to be displayed as brief information in the second area, upon identifying occurrence of the event.

3. The vehicle control apparatus of claim 2, wherein the controller is further configured to identify that the event occurs when at least one warning light is displayed on a cluster of the vehicle body.

4. The vehicle control apparatus of claim 2, wherein the controller is further configured to control the drive assembly to unfold the second area and the message to be displayed in the second area when the second area is in a folded state upon occurrence of the event.

5. The vehicle control apparatus of claim 1, wherein the brief information displayed in the second area comprises at least one on/off-settable item.

6. The vehicle control apparatus of claim 1, wherein the controller is further configured to control the brief information displayed in the second area to be specified and displayed as detailed information in the first area when a user touches a screen or makes a gesture to push down the screen using a finger.

7. The vehicle control apparatus of claim 1, wherein the controller is further configured to control the detailed information displayed in the first area to be simplified and displayed as brief information in the second area when the user touches the screen or makes a gesture to push up the screen.

8. The vehicle control apparatus of claim 1, wherein the controller is further configured to control the first area and the second area to be combined into one screen and the detailed information displayed in the first area to be displayed on the combined screen when the user touches the screen or makes the gesture to push up the screen.

9. The vehicle control apparatus of claim 1, wherein the vehicle body further comprises a hidden area hidden by a partial area of the display, and
the drive assembly is further configured to expose or avoid exposing the hidden area by changing the position of the display.

10. The vehicle control apparatus of claim 1, wherein the drive assembly is further configured to change the shape of the display by folding or unfolding a part of the display at a specific angle and to change the position of the display by moving the display upwardly or downwardly through sliding.

11. A vehicle control method comprising:
changing at least one of a shape of a display of a display device provided in a vehicle and a position of the display; and
displaying information on the display,
wherein a display area of the display is divided into a first area, a second area, and a third area arranged on a same surface,
the second area is positioned above the first area, and the third area is positioned under the first area,
at least one of the second area and the third area is folded or unfolded at a specific angle by the drive assembly, and
the displaying of the information comprises specifying brief information displayed in the second area and displaying the specified information as detailed information in the first area or simplifying the detailed information displayed in the first area and displaying the simplified information as brief information in the second area.

12. The vehicle control method of claim 11, wherein the displaying of the information comprises
displaying a message comprising a text indicating an event as brief information in the second area, upon identifying occurrence of the event.

13. The vehicle control method of claim 11, wherein the displaying of the information comprises identifying that the event occurs when at least one warning light is displayed on a cluster of the vehicle body.

14. The vehicle control method of claim 12, wherein the second area is unfolded and the message is displayed in the second area when the second area is in a folded state upon occurrence of the event.

15. The vehicle control method of claim 11, wherein the brief information displayed in the second area comprises at least one on/off-settable item.

16. The vehicle control method of claim 11, wherein the displaying of the information comprises specifying the brief information displayed in the second area and displaying the specified information as detailed information in the first area when the user touches the screen or makes the gesture to push down the screen using a finger.

17. The vehicle control method of claim 11, wherein the displaying of the information comprises simplifying the detailed information displayed in the first area and displaying the simplified information as brief information in the first area when the user touches the screen or makes the gesture to push up the screen using a finger.

18. The vehicle control method of claim 11, wherein the displaying of the information comprises combining the first area and the second area into one screen and displaying the detailed information displayed in the first area on the combined screen when the user touches the screen or makes the gesture to push up the screen.

19. The vehicle control method of claim 11, wherein the vehicle body further comprises a hidden area hidden by a partial area of the display, and
the vehicle control method further comprises exposing or avoiding exposing the hidden area by changing the position of the display.

20. The vehicle control method of claim 11, wherein the shape of the display is changed by folding or unfolding a part of the display at a specific angle, and
the position of the display is changed by moving the display upwardly or downwardly through sliding.

21. A computer program having stored thereon a computer-readable recording medium to execute the vehicle control method of claim 11 in connection to a computer which is hardware.
